(19) United States
(12) Patent Application Publication
(10) Pub. No.: US 2023/0119607 A1
(43) Pub. Date: Apr. 20, 2023

(54) LIGHTWEIGHT HAND-HELD LABEL APPLICATOR

(71) Applicant: Nam Sik KIM, Los Angeles, CA (US)

(72) Inventor: Nam Sik KIM, Los Angeles, CA (US)

(21) Appl. No.: 17/505,429

(22) Filed: Oct. 19, 2021

(51) Int. Cl. B65C 11/02; B65C 9/26

(52) U.S. Cl. CPC B65C 11/0231; B65C 9/262

(57) ABSTRACT

A lightweight hand-held label applicator includes a plate, a guide channel, a flexible wiping lip, and a strip container. The plate has a supplying surface and a sliding surface, and the strip is supplied along the supplying surface toward an edge of the plate. The plate is constructed to allow easy grip by a user's fingers on the supplying surface and the sliding surface such that the strip is in contact with the sliding surface and pulled away from the edge of the plate by the user's finger. Preferably, the user's thumb holds the supplying surface or the guide channel, and the user's index or middle finger holds the sliding surface and pulls the strip away from the edge of the plate.

### FIELD OF THE INVENTION

The present invention relates to a lightweight hand-held label applicator, and more particularly, a lightweight hand-held label applicator that, while simple in design, can efficiently apply a large number of labels from a strip to items.

### BACKGROUND OF THE INVENTION

Label applicators are used to apply labels to various items. The labels, which can be printed directly by the label applicator or a separate printer to include various information and/or ornamentation, typically are releasably attached to a backing strip to form a strip, usually a roll strip. Such a roll strip is mounted on a label applicator, and the labels are peeled off of the backing strip and attached to items by the label applicator.

Label applicators, which can be stationary or hand-held, typically include a roll strip container, printer, label dispenser, motor, battery, and handle. The strip may travel from the roll strip container to a printer so that the labels can be printed with intended information such as product information, logo or design, barcode, QR code, or the like. Then, the strip travels to the label dispenser where the labels are peeled off of the backing strip and attached to items such as products, packages, etc. The motor and battery are used to move the strip and the handle is used by a user to hold the label dispenser.

As noted above, the label applicator may or may not have a printer. If it does not have a printer, a strip with pre-printed labels is mounted on the label applicator. Also, the strip's movement may be powered by the motor and battery, or manually by a user. When the strip manually travels, the handle typically has a trigger and triggering structure to enable the movement of the strip by the trigger.

Each of the printer, motor, and battery can make the label applicator bulky and heavy. Even when the label application does not have a printer, motor, or battery, it is relatively bulky and heavy because of the handle, trigger, and triggering structure.

A bulky and heavy hand-held label applicator is not suitable for applying a large number of labels to items and may cause injury to a user, especially the user's hand after extended use. The applicator's weight may be decreased if it does not include a printer, motor, or battery; however, it still has to include a handle, trigger, and triggering structure, and is still relatively bulky and heavy.

Therefore, to solve the above problems, a lightweight hand-held label applicator, which has a simple structure, but is effective in quickly applying a large number of labels to items, is provided, as there is a need for a device that accomplishes this goal. This invention is directed to solve these problems and satisfy the long-felt need.

### SUMMARY OF THE INVENTION

The present invention contrives to solve the disadvantages of the prior art. The present invention provides a lightweight hand-held label applicator, which has a simple structure, but is effective in quickly applying a large number of labels to items.

The object of the invention is to provide a lightweight hand-held label applicator which includes a plate, a guide channel, a flexible wiping lip, and a strip container. The plate has a supplying surface and a sliding surface, and the strip is supplied along the supplying surface toward an edge of the plate. The plate is constructed to allow easy grip by a user's fingers on the supplying surface and the sliding surface such that the strip is in contact with the sliding surface and pulled away from the edge of the plate by the user's finger. Preferably, the user's thumb holds the supplying surface or the guide channel, and the user's index or middle finger holds the sliding surface and pulls the strip away from the edge of the plate.

The guide channel is formed on the supplying surface to laterally guide the movement of the strip. The flexible wiping lip is attached to an edge of the guide channel, and the strip container is formed on or attached to the supplying surface of the plate for mounting and storing the strip.

Another object of the invention is to provide a lightweight hand-held label applicator which includes a plate, a guide channel, and a flexible wiping lip, and does not include a strip container. The plate has a supplying surface and a sliding surface, and the strip is supplied along the supplying surface toward an edge of the plate. The plate is constructed to allow easy grip by a user's fingers on the supplying surface and the sliding surface such that the strip is in contact with the sliding surface and pulled away from the edge of the plate by the user's finger. Preferably, the user's thumb holds the supplying surface or the guide channel, and the user's index or middle finger holds the sliding surface and pulls the strip away from the edge of the plate. The guide channel is formed on the supplying surface to laterally guide the movement of the strip, and the flexible wiping lip is attached to an edge of the guide channel.

Yet another object of the invention is to provide a lightweight hand-held label applicator which includes a plate, a guide channel, a flexible wiping lip, a strip container, an item contact roller, and an idler roller. The plate has a supplying surface and a bottom surface. The strip is supplied along the supplying surface toward an edge of the plate, and the strip is pulled backward below the bottom surface. The guide channel is formed on the supplying surface to laterally guide the movement of the strip. The item contact roller and idler roller are located below the bottom surface such that the strip passes through in between the item contact roller and the idler roller. The item contact roller is located slightly below the idler roller such that the item contact roller contacts and rolls on a surface of the item to pull the strip.

The advantages of the present invention are: (1) the label applicator of the present invention has a very simple structure, but it is easy-to-use and very effective in quickly applying a large number of labels to items; (2) the label applicator of the present invention is lightweight and convenient to use, and thus, is less likely to cause injury especially when a user uses it for an extended period of time; (3) using the present invention, a user can work very fast in applying a large number of labels to items; (4) the present invention has a very simple structure that is easy to manufacture at a low cost; and (5) because of its simple structure, it is easy to clear label jams or remove labels stuck in the label applicator.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 shows a perspective view of the lightweight hand-held label applicator according to one embodiment of the present invention;

FIG. 2 shows another perspective view of the lightweight hand-held label applicator according to one embodiment of the present invention;

FIG. 3 shows a side view of the lightweight hand-held label applicator according to one embodiment of the present invention;

FIGS. 4A, 4B, and 4C show side views of the lightweight hand-held label applicator according to one embodiment of the present invention showing placements of the user's fingers to hold and use the invention;

FIG. 5 shows a top view of the invention according to another embodiment of the present invention;

FIG. 6 shows a perspective view of the invention according to another embodiment of the present invention;

FIG. 7 shows a partial perspective view of the invention according to another embodiment of the present invention;

FIG. 8 shows a side view of the invention according to another embodiment of the present invention;

FIGS. 9A and 9B show side views of the invention according to another embodiment of the present invention showing placements of the user's fingers to hold and use the invention;

FIG. 10 shows a perspective view of the invention according to still another embodiment of the present invention;

FIG. 11 shows a side view of the invention according to still another embodiment of the present invention; and

FIG. 12 shows a partial strip of labels which are releasably attached to a backing strip where barcodes are printed on the labels.

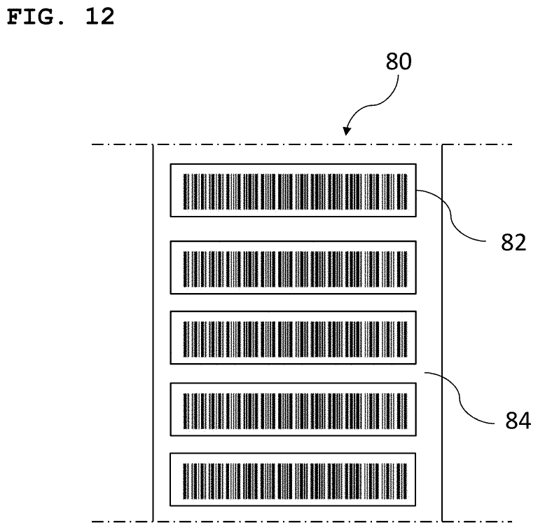

### DETAILED DESCRIPTION OF EMBODIMENTS OF THE INVENTION

Reference will now be made in detail to the preferred embodiments of the present invention, examples of which are illustrated in the accompanying drawings, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention.

Also, as used in the specification including the appended claims, the singular forms “a”, “an”, and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about”, it will be understood that the particular value forms another embodiment.

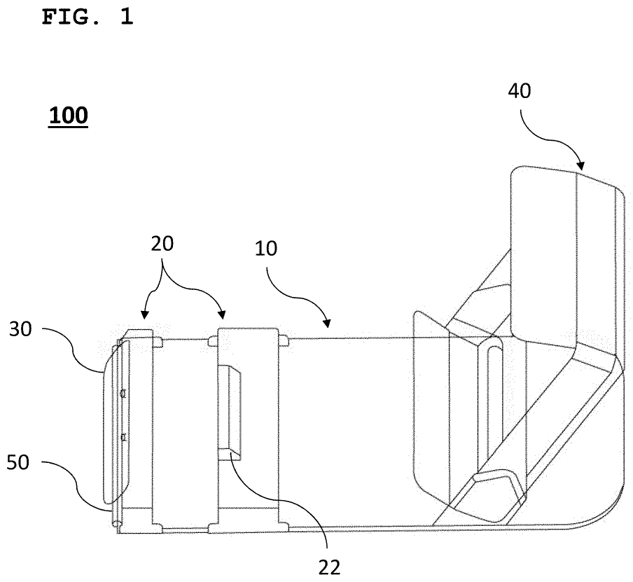

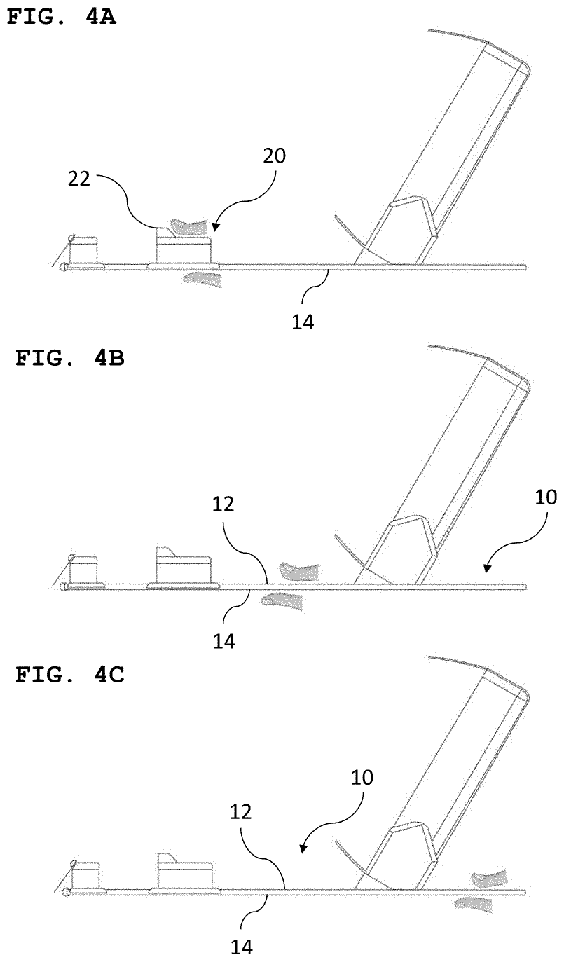

FIGS. 1-3, 4A, 4B, and 4C show an embodiment of the present invention. A strip 80 of labels 82 and a backing strip 84 is mounted on the lightweight hand-held label applicator 100 of the present invention, and then, the label applicator 100 separates the labels from the backing strip and applies the labels to items. The label applicator 100 includes a plate 10, a guide channel 20, a flexible wiping lip 30, and a strip container 40. The plate 10 has a supplying surface 12 and a sliding surface 14, and the strip 80 is supplied along the supplying surface 12 toward an edge 15 of the plate 10. The plate 10 is constructed to allow easy grip by a user's fingers on the supplying surface 12 and the sliding surface 14 such that the strip 80 is in contact with the sliding surface 14 and pulled away from the edge 15 of the plate 10 by the user's finger. Preferably, the user's thumb holds the supplying surface 12 or the guide channel 20, and the user's index or middle finger holds the sliding surface 14 and pulls the strip 80 away from the edge 15 of the plate 10. Even if the supplying surface 12 is constructed for easy grip by the user's thumb, the user's thumb may hold the top surface of the guide channel 20.

The guide channel 20 is formed on the supplying surface 12 to laterally guide the movement of the strip 80. The guide channel 20 and the plate 10 may be integral with each other as a single piece, or they may be manufactured in two or more sections and assembled together. The flexible wiping lip 30 is attached to an edge of the guide channel 20, and the strip container 40 is formed on or attached to the supplying surface 12 of the plate 10 for mounting and storing the strip 80. The flexible wiping lip 30 may be manufactured from food grade polypropylene or any other material suitable for wiping or pressing the labels to help easy attachment of the labels to items.

The label application 100 may further include a cylindrical separator 50 formed on or attached to the edge 15 of the plate 10. The cylindrical separator 50 helps smooth movement of the strip 80 and easy separation of the labels 82 from the backing strip 84. The separator 50 may be integrally manufactured with the plate 10 as a single piece. Alternatively, the separator 50 may be separately manufactured and made of flexible material and installed on the edge 15 of the plate 10. The edge 15 of the plate 10 may have a cylindrical bulge to prevent the separator from being dislodged.

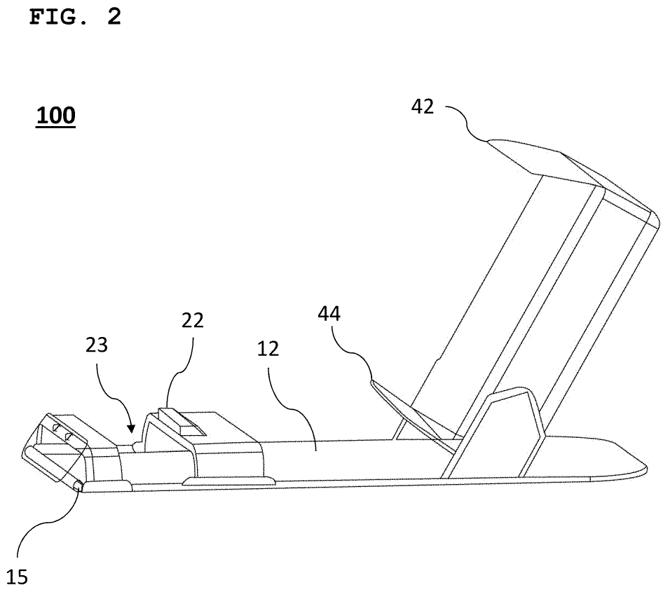

A window 23 may be formed on the guide channel 20 so that contents of the labels 82 are visible right before being applied to items. The window 23 may be an opening or made of a glass, film or transparent material. As shown in FIGS. 1 and 2, the guide channel 20 may be comprised of two spaced apart structures and the window 23 is an open space between the two spaced apart structures.

The widths of the backing strip 84 may be 1″, 2.25″, 3″, or 4″, and the label application 100 may be manufactured to accommodate only one size. Alternatively, the guide channel 20 may be constructed to adjust its width to accommodate different sizes (widths) of the backing strip 84.

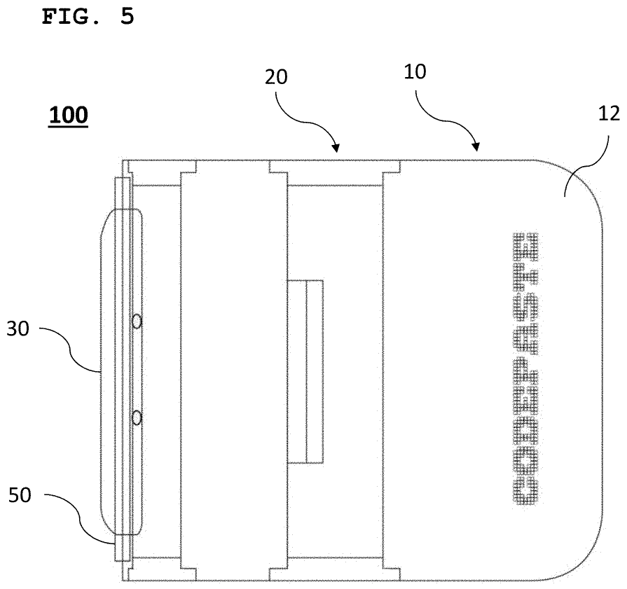

As shown in FIG. 1, a press ridge 22 may be formed on a top surface of the guide channel 20 such that when the user's index or middle finger pulls the strip 80 along the sliding surface 14 of the plate 10, the user's thumb presses the press ridge 22 to offset the pulling force. A raised or embossed logo as in FIG. 5 may be formed on the supplying surface 12 of the plate 10 for the same purpose of pressing thereon by the user's thumb to generate a frictional force to offset the pulling force. Anti-slip material may be used to increase the frictional force.

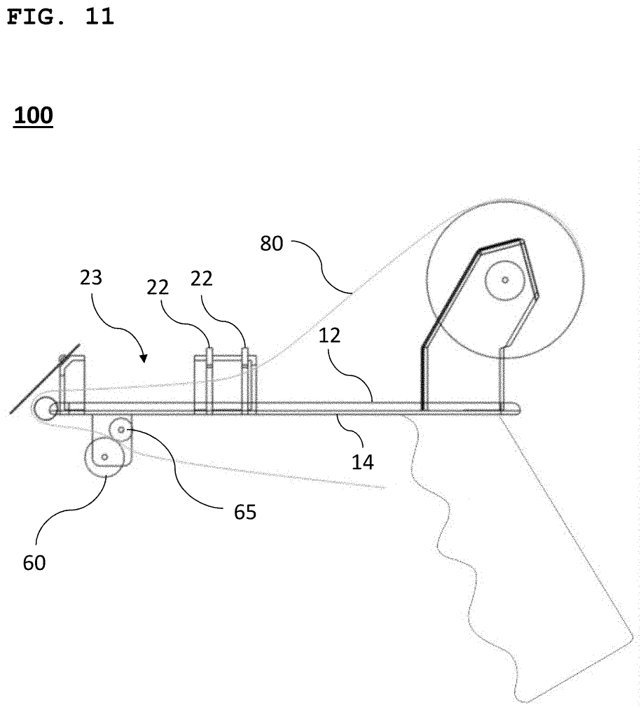

As shown in FIG. 11, a pair of press ridges 22 may be formed on the top surface of the guide channel 20 such that the press ridges 22 are parallel to each other and spaced apart in order for the user's thumb to be placed about in between the press ridges 22. In this way, the offsetting force can be effectively increased. More than two press ridges 22 may be used or anti-slip material may be additionally used.

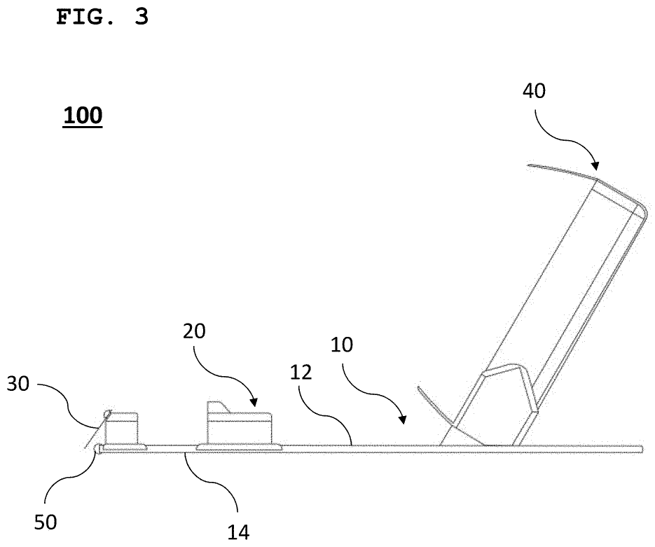

The strip container 40 may be box-shaped with its top side being open and extends diagonally from the supplying surface 12 of the plate 10 as shown in FIG. 3. The strip container 40 may further include a top flap 42 and a bottom flap 44 for smooth movement of the strip 80 out of the strip container 40. The top and bottom flaps 42, 44 may be inwardly arcuate or curved. In the alternative embodiment, the strip container 40 may be formed in a circular shape to accommodate a roll of strip 80.

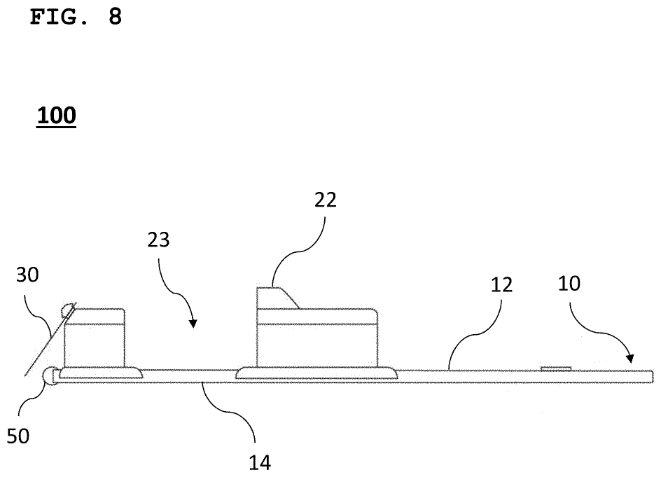

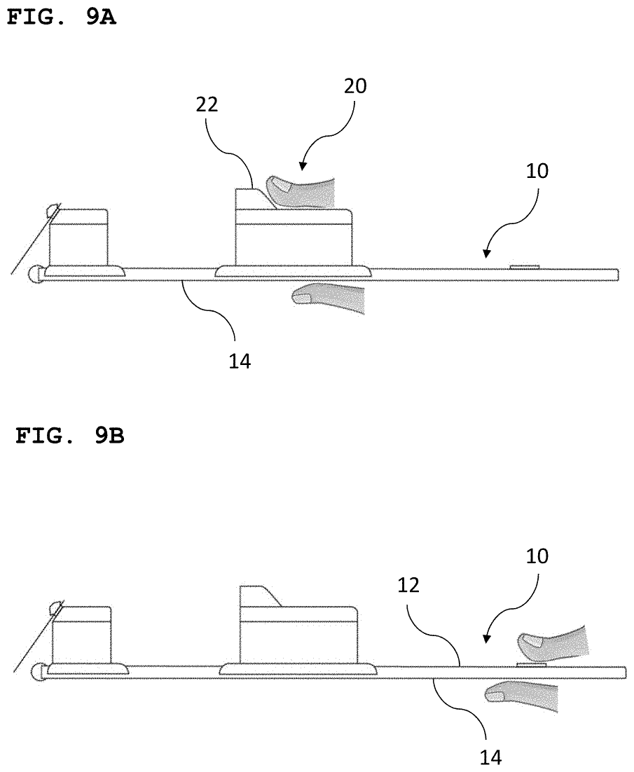

FIGS. 5-8, 9A, and 9B show an alternative embodiment of the present invention. A strip 80 of labels 82 and a backing strip 84 is installed on the lightweight hand-held label applicator 100 of the present invention, and then, the label applicator 100 separates the labels from the backing strip and applies the labels to items. The label applicator 100 includes a plate 10, a guide channel 20, and a flexible wiping lip 30. The plate 10 has a supplying surface 12 and a sliding surface 14, and the strip 80 is supplied along the supplying surface 12 toward an edge 15 of the plate 10. The plate 10 is constructed to allow easy grip by a user's fingers on the supplying surface 12 and the sliding surface 14 such that the strip 80 is in contact with the sliding surface 14 and pulled away from the edge 15 of the plate 10 by the user's finger. Preferably, the user's thumb holds the supplying surface 12 or the guide channel 20, and the user's index or middle finger holds the sliding surface 14 and pulls the strip 80 away from the edge 15 of the plate 10. Even if the supplying surface 12 is constructed for easy grip by the user's thumb, the user's thumb may hold the top surface of the guide channel 20.

The guide channel 20 is formed on the supplying surface 12 to laterally guide the movement of the strip 80. The guide channel 20 and the plate 10 may be integral with each other as a single piece, or they may be manufactured in two or more sections and assembled together. The flexible wiping lip 30 is attached to an edge of the guide channel 20. The flexible wiping lip 30 may be manufactured from food grade polypropylene or any other material suitable for wiping or pressing the labels to help easy attachment of the labels to items.

The label application 100 may further include a cylindrical separator 50 formed on or attached to the edge 15 of the plate 10. The cylindrical separator 50 helps smooth movement of the strip 80 and easy separation of the labels 82 from the backing strip 84. The separator 50 may be integrally manufactured with the plate 10 as a single piece. Alternatively, the separator 50 may be separately manufactured and made of flexible material and installed on the edge 15 of the plate 10. The edge 15 of the plate 10 may have a cylindrical bulge to prevent the separator from being dislodged.

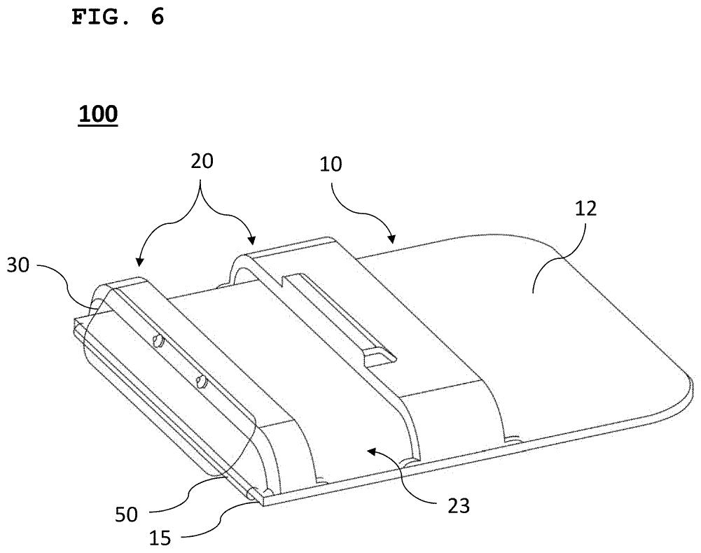

A window 23 may be formed on the guide channel 20 so that contents of the labels 82 are visible right before being applied to items. The window 23 may be an opening or made of a glass, film or transparent material. As shown in FIG. 6, the guide channel 20 may be comprised of two spaced apart structures and the window 23 is an open space between the two spaced apart structures.

The widths of the backing strip 84 may be 1″, 2.25″, 3″, or 4″, and the label application 100 may be manufactured to accommodate only one size. Alternatively, the guide channel 20 may be constructed to adjust its width to accommodate different sizes (widths) of the backing strip 84.

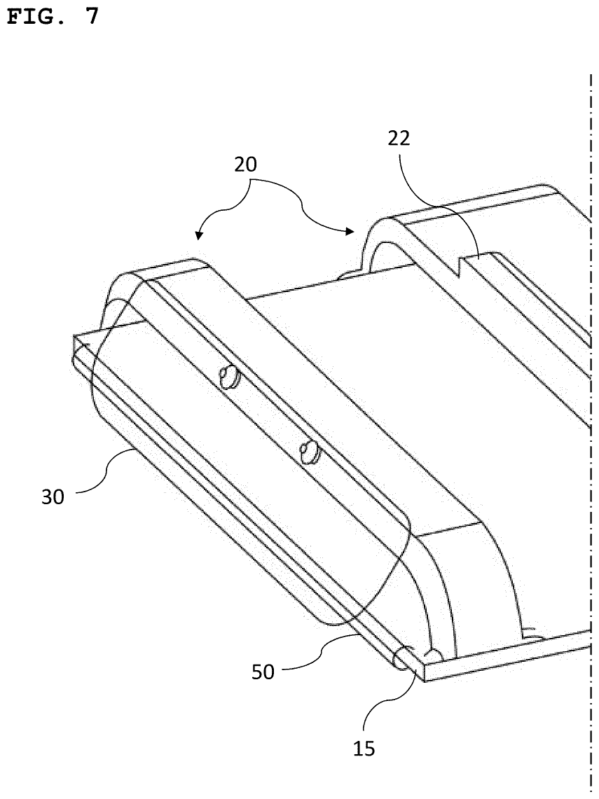

As shown in FIG. 7, a press ridge 22 may be formed on a top surface of the guide channel 20 such that when the user's index or middle finger pulls the strip 80 along the sliding surface 14 of the plate 10, the user's thumb presses the press ridge 22 to offset the pulling force. A raised or embossed logo as shown in FIG. 5 may be formed on the supplying surface 12 of the plate 10 for the same purpose of pressing thereon by the user's thumb to generate a frictional force to offset the pulling force. Anti-slip material may be used to increase the frictional force.

As shown in FIG. 11, a pair of press ridges 22 may be formed on the top surface of the guide channel 20 such that the press ridges 22 are parallel to each other and spaced apart in order for the user's thumb to be placed about in between the press ridges 22. In this way, the offsetting force can be effectively increased. More than two press ridges 22 may be used or anti-slip material may be additionally used.

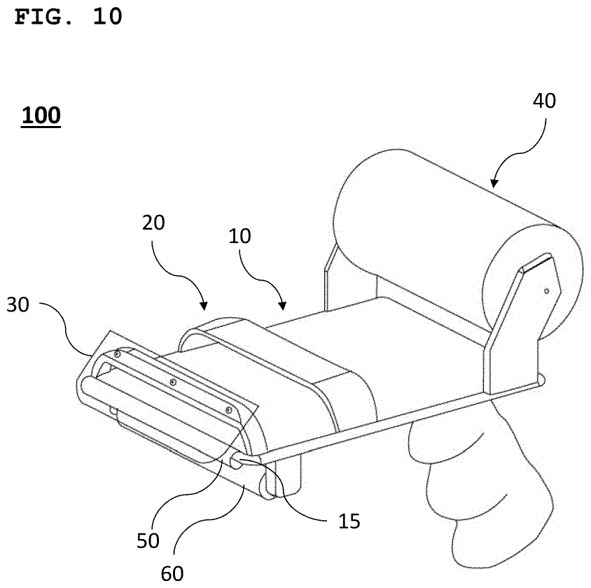

FIGS. 10 and 11 show still another embodiment of the present invention. The label applicator 100 includes a plate 10, a guide channel 20, a flexible wiping lip 30, a strip container 40, an item contact roller 60, and an idler roller 65. The plate 10 has a supplying surface 12 and a bottom surface 14. The strip 80 is supplied along the supplying surface 12 toward an edge 15 of the plate 10, and the strip 80 is pulled backward below the bottom surface 14. The guide channel 20 is formed on the supplying surface 12 to laterally guide the movement of the strip 80. The guide channel 20 and the plate 10 may be integral with each other as a single piece, or they may be manufactured in two or more sections and assembled together. The flexible wiping lip 30 is attached to an edge of the guide channel 20. The flexible wiping lip 30 may be manufactured from food grade polypropylene or any other material suitable for wiping or pressing the labels to help easy attachment of the labels to items.

The strip container 40 is formed on or attached to the supplying surface 12 of the plate 10 for storing the strip 80. The strip container 40 may be box-shaped or circular-shaped as a roll container. The item contact roller 60 and idler roller 65 are located below the bottom surface 14 such that the strip 80 passes through in between the item contact roller 60 and the idler roller 65. The item contact roller 60 is located slightly below the idler roller 65 such that the item contact roller 60 contacts and rolls on a surface of the item to pull the strip 80. In the alternative embodiment, there is only one roller of the item contact roller 60 and the strip 80 travels between the item contact roller and the bottom surface 14.

The label application 100 may further include a cylindrical separator 50 formed on or attached to the edge 15 of the plate 10. The cylindrical separator 50 helps smooth movement of the strip 80 and easy separation of the labels 82 from the backing strip 84. The separator 50 may be integrally manufactured with the plate 10 as a single piece. Alternatively, the separator 50 may be separately manufactured and made of flexible material and installed on the edge 15 of the plate 10. The edge 15 of the plate 10 may have a cylindrical bulge to prevent the separator from being dislodged.

A window 23 may be formed on the guide channel 20 so that contents of the labels 82 are visible right before being applied to items. The window 23 may be an opening or made of a glass, film or transparent material. As shown in FIG. 10, the guide channel 20 may be comprised of two spaced apart structures and the window 23 is an open space between the two spaced apart structures.

The widths of the backing strip 84 may be 1″, 2.25″, 3″, or 4″, and the label application 100 may be manufactured to accommodate only one size. Alternatively, the guide channel 20 may be constructed to adjust its width to accommodate different sizes (widths) of the backing strip 84.

As shown in FIG. 1 or 7, a press ridge 22 may be formed on a top surface of the guide channel 20 such that when the user's index or middle finger pulls the strip 80 along the sliding surface 14 of the plate 10, the user's thumb presses the press ridge 22 to offset the pulling force. A raised or embossed logo as shown in FIG. 5 may be formed on the supplying surface 12 of the plate 10 for the same purpose of pressing thereon by the user's thumb to generate a frictional force to offset the pulling force. Anti-slip material may be used to increase the frictional force.

As shown in FIG. 11, a pair of press ridges 22 may be formed on the top surface of the guide channel 20 such that the press ridges 22 are parallel to each other and spaced apart in order for the user's thumb to be placed about in between the press ridges 22. In this way, the offsetting force can be effectively increased. More than two press ridges 22 may be used or anti-slip material may be additionally used.

The strip container 40 is constructed to store a roll of the strip 80. The strip container 40 may be box-shaped with its top side being open and extends diagonally from the supplying surface, or circular shaped to store a roll of the strip 80.

While the invention has been shown and described with reference to different embodiments thereof, it will be appreciated by those skilled in the art that variations in form, detail, compositions and operation may be made without departing from the spirit and scope of the invention as defined by accompanying claims.

What is claimed is:

1. A lightweight hand-held label applicator for placing a strip of labels and a backing strip, separating the labels from the backing strip, and applying the labels to items, the label applicator comprising:
a plate having a supplying surface and a sliding surface wherein the strip is supplied along the supplying surface toward an edge of the plate, and wherein the plate is constructed to allow easy grip by a user's fingers on the supplying surface and the sliding surface such that the strip is in contact with the sliding surface and pulled away from the edge of the plate by the user's finger;
a guide channel formed on the supplying surface to laterally guide a movement of the strip;
a flexible wiping lip attached to an edge of the guide channel; and
a strip container formed on or attached to the supplying surface for storing the strip.

2. The label application of claim 1, further comprising a cylindrical separator formed on or attached to the edge of the plate.

3. The label application of claim 2, wherein the cylindrical separator is made of flexible material.

4. The label application of claim 1, wherein a window is formed on the guide channel so that contents of the labels are visible.

5. The label application of claim 1, the guide channel is constructed to adjust its width to accommodate different sizes of the backing strip.

6. The label application of claim 1, wherein a press ridge is formed on a top surface of the guide channel.

7. The label application of claim 1, wherein a pair of press ridges is formed on a top surface of the guide channel wherein the press ridges are parallel to each other and spaced apart such that a thumb of the user can be placed about in between the press ridges.

8. The label application of claim 1, wherein the strip container is box-shaped with its top side being open and extends diagonally from the supplying surface.

9. The label application of claim 8, wherein the strip container includes a top flap and a bottom flap.

10. The label application of claim 9, wherein the top and bottom flaps are inwardly aruate.

11. A lightweight hand-held label applicator for placing a strip of labels and a backing strip, separating the labels from the backing strip, and applying the labels to items, the label applicator comprising:
a plate having a supplying surface and a sliding surface wherein the supplying surface and the sliding surface are flat, disposed on opposite sides of the plate, and parallel to each other such that the strip is supplied along the supplying surface toward an edge of the plate, and the backing strip is in contact with the sliding surface and pulled away from the edge of the plate by a finger of a user;
a guide channel formed on the supplying surface to laterally guide a movement of the strip; and
a flexible wiping lip attached to an edge of the guide channel,
wherein the plate is sized to allow the user to grip both of the supplying surface and the sliding surface by fingers of a hand of the user.

12. The label application of claim 11, further comprising a cylindrical separator formed on or attached to the edge of the plate, wherein the cylindrical separator is made of flexible material.

13. The label application of claim 11, wherein a window is formed on the guide channel so that contents of the labels are visible.

14. The label application of claim 11, wherein a press ridge is formed on a top surface of the guide channel.

15. A lightweight hand-held label applicator for placing a strip of labels and a backing strip, separating the labels from the backing strip, and applying the labels to items, the label applicator comprising:
a plate having a supplying surface and a bottom surface wherein the strip is supplied along the supplying surface toward an edge of the plate and the strip is pulled backward below the bottom surface;
a guide channel formed on the supplying surface to laterally guide a movement of the strip;
a flexible wiping lip attached to an edge of the guide channel;
a strip container formed on or attached to the supplying surface for storing the strip; and
an item contact roller and an idler roller located below the bottom surface,
wherein the strip passes through in between the item contact roller and the idler roller,
wherein the item contact roller is located slightly below the idler roller such that the item contact roller contacts and rolls on a surface of the item to pull the strip.

16. The label application of claim 15, further comprising a cylindrical separator formed on or attached to the edge of the plate, wherein the cylindrical separator is made of flexible material.

17. The label application of claim 15, wherein a window is formed on the guide channel so that contents of the labels are visible.

18. The label application of claim 15, wherein a press ridge is formed on a top surface of the guide channel.

19. The label application of claim 15, wherein the strip container is constructed to store a roll of the strip.

20. The label application of claim 15, wherein the strip container is box-shaped with its top side being open and extends diagonally from the supplying surface.
